(19) United States
(12) Patent Application Publication
(10) Pub. No.: US 2007/0288384 A1
(43) Pub. Date: Dec. 13, 2007

(54) System and Method for Distributing a Multimedia Presentation

(76) Inventors: Harry J. Pappas, Reno, NV (US); Rosemary Danon, Los Angeles, CA (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/423,867

(22) Filed: Jun. 13, 2006

(51) Int. Cl. H04L 9/00

(52) U.S. Cl. 705/52

(57) ABSTRACT

A method is provided to distribute a multimedia presentation. The method includes receiving and storing submitter profile data representing a submitter, subscriber profile data representing a subscriber, and multimedia presentation data representing a multimedia presentation associated with the submitter. The method further includes analyzing the submitter profile data and the multimedia presentation data to determine a presentation rating associated with the multimedia presentation. Based on the presentation rating, the availability of the multimedia presentation is published to the subscriber. The method also includes receiving a request from the subscriber to view the multimedia presentation, delivering the multimedia presentation data to the subscriber, and receiving feedback from the subscriber. The submitter profile data, the subscriber profile data, and/or the multimedia presentation data is updated to reflect the feedback.

### BACKGROUND

The present invention relates generally to network systems. It finds particular applicability in conjunction with communication based networks and will be described with particular reference thereto. It is to be appreciated however, that the invention finds further application in systems and devices where it is desirable to receive targeted or viewer selected multimedia presentations.

Traditional video broadcasting companies required sophisticated and expensive equipment to operate. Such broadcasting activity has generally been limited to companies with extensive human and financial resources. Over time, technology, particularly the Internet, has reduced the resource requirements for potential broadcasters and has enhanced information and entertainment experiences for viewers.

The availability of digital recording and networking technology has allowed a number of users to be able to easily create near-professional multimedia presentations that would be of interest to a wide spectrum of viewers. Similarly, viewers are constantly searching for multimedia presentations that are specifically targeted to their interests.

### BRIEF DESCRIPTION OF THE DRAWINGS

In the accompanying drawings which are incorporated in and constitute a part of the specification, embodiments are illustrated which, together with the detailed description given below, serve to describe exemplary embodiments. It will be appreciated that the illustrated boundaries of elements (e.g. boxes, groups of boxes, or other shapes) in the figures represent but exemplary boundaries. One of ordinary skill in the art will appreciate, for example, that one element may be designed as multiple elements or that multiple elements may be designed as one element. An element shown as an internal component of another element may be implemented as an external component and vice versa.

FIG. 1 is a system diagram illustrating an embodiment of a multimedia distribution network.

FIG. 2 is a functional block diagram illustrating an embodiment of a multimedia distribution system.

FIG. 3 illustrates one embodiment of a methodology for distributing a multimedia presentation to a viewer.

### DESCRIPTION OF THE ILLUSTRATED EMBODIMENTS

The following description includes definitions of selected terms used throughout the disclosure. Both singular and plural forms of all terms fall within each meaning:

“Computer-readable medium”, as used herein, refers to any medium that participates directly or indirectly in providing signals, instructions and/or data to one or more processors for execution Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of acoustic or light waves, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or cartridge, a carrier wave/pulse, or any other medium from which a computer, a processor or other electronic device can read.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), a programmed logic device, memory device containing instructions, or the like. Logic may also be fully embodied as software.

“Signal”, as used herein, includes but is not limited to one or more electrical or optical signals, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries Software may also be implemented in various forms such as a stand-alone program, a function call, a servlet, an applet, instructions stored in a memory, part of an operating system or other type of executable instructions It will be appreciated by one of ordinary skill in the art that the form of software is dependent on, for example, requirements of a desired application, the environment it runs on, and/or the desires of a designer/programmer or the like.

“User”, as used herein, includes but is not limited to one or more persons, software, computers or other devices, or combinations of these.

“Submitter,” as used herein, includes but is not limited to one or more persons, software, computers or other devices, or combinations of these for providing multimedia presentations

“Subscriber,” as used herein, includes but is not limited to one or more persons, software, computers or other devices, or combinations of these for requesting, receiving, viewing and providing feedback regarding multimedia presentations.

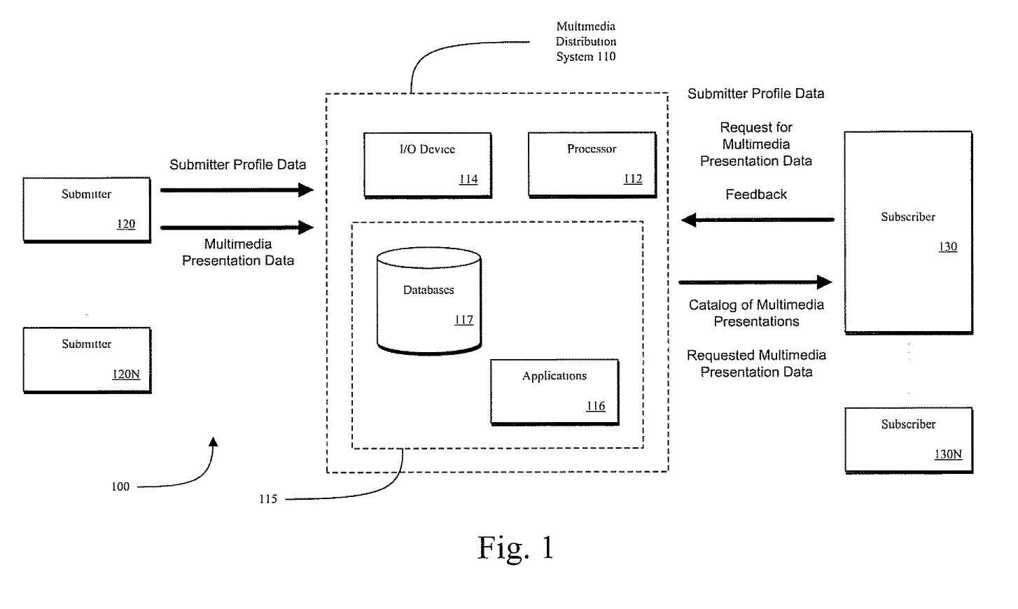

A simple exemplary embodiment of a multimedia distribution network is illustrated in FIG. 1. Network 100 includes a multimedia distribution system 110, a plurality of submitters 120-120N (two shown), and a plurality of subscribers 130-130N (two shown). The multimedia distribution system 110 communicates with the plurality of submitters 120-120N and the plurality of subscribers 130-130N. The various components of network 100 may employ any conventional transmission medium, such as such as conventional wireline networks, which include twisted pair, Hybrid Fiber Coaxial (HFC) fiber optics and the like; terrestrial wireless networks; and satellite or other aloft networks, for example.

The multimedia distribution system 110 generally receives submitter profile data from a submitter, such as submitter 120. The submitter profile data may include data which describes the submitter, such as a submitter identifier for uniquely identifying each submitter, for example. The submitter profile data may further include one or more submitter ratings which may be used to identify a quality, interest group, or level of desirability of distributing multimedia presentations received from a submitter

The multimedia distribution system 110 also receives multimedia presentation data from the submitter 120. The multimedia presentation data may include digitized audio and video captured, prepared and/or produced by the submitter. The multimedia presentation data may also include a presentation identifier to uniquely identify the presentation, a category indication, an associated submitter identifier, and a presentation rating which may be used to identify a level of quality or other characteristic of the presentation.

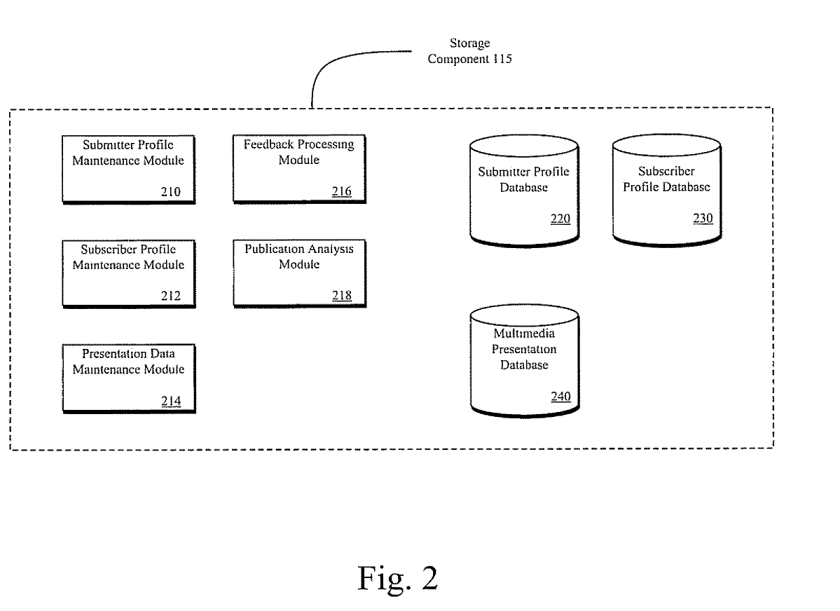

The multimedia distribution system 110 includes a processor 112, an 1/O device 114, and a memory or storage component 115 which stores a plurality of software applications 116 and a plurality of databases 117. Applications 116 and databases 117 are discussed in greater detail with reference to FIG. 2.

Communication between subscriber 130 and multimedia distribution system 110 generally includes transmission of subscriber profile data, requests for multimedia presentation data and feedback from subscriber 130 to multimedia distribution system 110. Communications from multimedia distribution system 110 to subscriber 130 include transmission of a catalog of available multimedia presentations and requested multimedia presentation data as requested by subscriber 130.

It should be appreciated that in some embodiments the multimedia distribution system 110 may directly provide all of the services and data necessary for submitter 120 and subscriber 130, or may act as a distributor of other providers' services and data. It should be further appreciated that submitter 120 and subscriber 130 include a variety of portable, mobile, analog cellular or digital devices, video and audio equipment, desk-top computers and the like.

Referring now to FIG. 2, there is illustrated a more detailed depiction of memory or storage component 115 of multimedia distribution system 110. Memory 115 includes submitter profile maintenance module 210 for receiving, stoning, updating and maintaining submitter profile data stored in submitter profile database 220. Memory 115 also includes subscriber profile maintenance module 210 for receiving, storing, updating and maintaining subscriber profile data stored in subscriber profile database 230.

Multimedia presentation data is stored in multimedia presentation database 240, and is received, stored, updated and maintained by presentation data maintenance module 214. Memory 115 further includes feedback processing module 216 which includes logic for processing feedback received from subscribers. Memory 115 also includes publication analysis module 218. Publication analysis module 218 includes logic for determining whether a multimedia presentation should be available to subscribers.

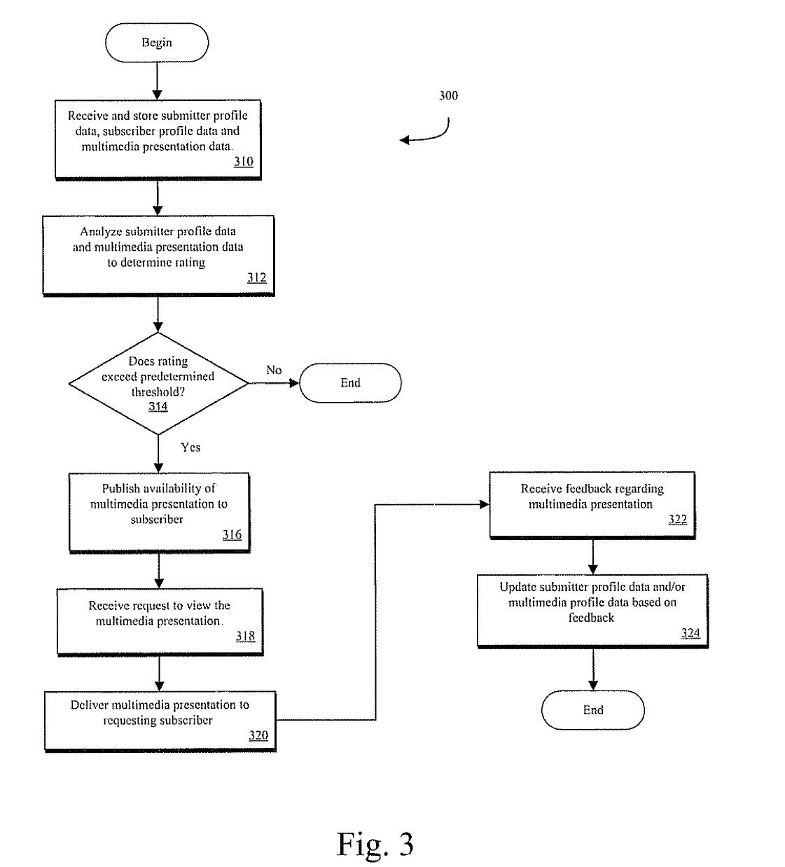

Referring now to FIG. 3, there is a flowchart illustrating an example methodology 300 for distributing multimedia presentation data from a submitter to a subscriber. At block 310, the multimedia distribution system 110 receives submitter profile data from a submitter 120. The submitter profile data is stored in submitter profile database 220, The multimedia distribution system 110 also receives multimedia presentation data submitter 120, and stores the multimedia presentation data in multimedia presentation database 240. At block 310, the multimedia distribution system 110 further receives subscriber profile data from a subscriber 130. The subscriber profile data is stored in subscriber profile database 230

At block 312, the submitter profile data and/or the multimedia presentation data are analyzed to determine a presentation rating. The presentation rating may be based on the number of hits associated with the multimedia presentation Alternatively, the presentation rating may be based on the number of hits associated with the submitter of the presentation. Other factors which may influence the presentation rating include a submitter quality rating, the number of presentations associated with the submitter, or the topic of the presentation.

The presentation rating is compared to a predetermined threshold value at block 314, and if the presentation rating is below the threshold, the presentation is not made available to the subscribers. If the presentation rating is sufficiently high, the presentation is made available to the subscribers at block 316. Availability of the presentation may be published in a number of ways.

At block 318, a request to view the presentation is received from subscriber 130. The multimedia presentation data is delivered to the requesting subscriber 130 at block 320, and at block 322 feedback regarding the presentation is received from the viewing subscriber 130. Feedback may relate to the quality of the submitter, the quality of the presentation, the relevance of the presentation to a particular topic category or any of the criteria used to determine the presentation rating at block 312.

Upon receiving the feedback from subscriber 130, appropriate data is updated based on the feedback, as illustrated at block 324. For example, if the feedback related to the quality of the submitted, the submitter profile data associated with the presentation's submitter would be updated to reflect the feedback.

The above described embodiment illustrates one example methodology for implementing the present invention to enable publication of personal content. A number of peer-to-peer sites on the Internet demonstrate that people want to share that content which they have created The present application provides an excellent combination of ubiquitous media—television and the Internet—for distributing the quality user-generated content to a wide audience.

As an open multi-media forum for the general public, the disclosed application liberates viewers in an era in which most mass media is dominated and owned by a few mega companies. The spirit of American volunteerism is well known and ingrained in American society. Since the founding of our country, neighbor has helped neighbor. The disclosed application provides a new way to let the peoples' voices be heard by enabling viewers to create content of their own which local broadcasters can showcase to the greatest number of each market's residents

With advances in technology, more and more people carry still cameras or video cameras with them at all times on their mobile phones. News crews cannot always be at the right place at the right time. An excellent example is the London subway bombing of 2005, where the only footage available was captured on video-enabled cellphones. Additionally, viewers now have the ability to capture breaking news when conventional news crews cannot get to the scene in time.

While some news media have reached out to its viewers to contribute content, the final decision on publishing still lies with editors. The present application allows users to determine what is news by auto-publishing content from cell phones, e-mail, and online with text, photos and video.

After registering, volunteer video journalists may use phones with video or picture capability, camcorders, digital still cameras, or PCs to write, shoot, and produce their own stories. When submitting articles, users may write a headline, copy, and if available, post a photo or video clip. Videos and pictures with script and sound can be e-mailed to a multimedia distribution system, such as a web site, and from there, each story may be posted on a community web site.

The user-generated material is published on the site, subject to certain restrictions on content that may be deemed offensive by contemporary community standards. Contributors' stories may be published simultaneously on the Homepage and in one of the following subject categories:
News: Video, photos and information about newsworthy items, which may become a part of a local news broadcast.
Weather: Video, pictures and information on weather, which may be used on a local news or weathercast.
Community: Video, photos and information about happenings within the community.
Sports: Professional, college, or youth, as well as company softball, bowling, soccer, and golf teams.
Fun: Videos, pictures and information about local citizens at play.
Our Troops: Of, by, and for the troops serving in the Armed Forces all over the world, consisting of pictures from the battlefield, letters to home, or tributes to soldiers.

People from all walks of life are welcome to participate. From firemen and physicians to college and high school students to professors at colleges and universities, all are welcome because they each have something to offer. Users may initiate their own stories based on their interests, experience, and knowledge. Among the benefits to contributors are the opportunity for community service, exposure and notoriety, and the chance to inform and educate the community.

Among other benefits, the present application provides an archive of each day in the life of the community as it happens. Users can click on any month and date to see the “day” as it happened, as told by the public. Additionally, the search function may be used to look for specific subject matter.

In addition to posting stories, users may be able to comment on stories and rate them. Commenting on an article will alert others that it has attracted interest. The more comments, the higher the article will be listed on a page of Hot Topics. Through unique methodologies, the best of this content may be selected to air on local TV stations The rating system may also “flag” correspondents that have talent and access to interesting news These highly-rated articles may get special attention from other traditional news organizations

In the example embodiment, the multimedia distribution system includes a web site for publishing the submitted content The content is automatically published to the with equality given to all as far as space and positioning In one alternative, the site is built to be a “day in the life” of a community, and at 11:59 pm the date expires the page and moves all content published that day to an archive system. At 12:00 midnight, the page goes blank, and the day begins anew with the first story being published whenever someone publishes it. The archives are then searchable by “day” or subject or author. Subject and/or author searches may carry rating and/or history information. Depending on the hierarchy/rating system employed in a particular embodiment, a qualifying multi-media presentation could be pushed to a broadcast station newsroom server, thereby giving a local story submitted to the website by a local user/community correspondent an equal level of importance in top stories being reviewed by the news personnel. In that way, the local story is automatically available for use on a broadcast news program—much the same way that news organizations such as CNN might put a major breaking story at the top of their “multi-media presentation” that automatically goes into the newsroom server by contract.

Of course, the ultimate publishing selection could also apply to any selective service such as Tivo's new “link to web content on my personal computer.” One could refine the criteria in the same way and have only the “most important/relevant” as created by one's usage or one's network of friends' usage that would determine what one wants sent to the server on top of one's TV set for availability when watching TV in one's home. This could also be the criteria for universities to create servers of content by same criteria. For example, the users could be experts in a field thereby giving authenticity and relevance criteria to numerous articles available on a given subject. In essence, this is a type of automated preferred usage pattern and referral system of RSS type of distribution, and an excellent way to break thru the clutter given the overwhelming amount of content available. Content could be selected by specific criteria and automatically published on whatever platform designated.

Another potential use of this algorithm could be on the “social network” sites such as My Space. For example, one might have files pushed to him/her by friends based on specifications as well as files that would be pushed to everyone in one's network that he/she participated in ranking. This would create an excellent opportunity for one to “share” favorite songs, videos and articles as well as receive friends' favorites on an automated basis. Similar to the way the Internet is currently filled with user referred links, this embodiment could have an automated cue based on predetermined ratings that would be sent to my designated server.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A computer-implemented method for distributing a multimedia presentation, comprising:
receiving and storing submitter profile data representing a submitter, subscriber profile data representing a subscriber, and multimedia presentation data representing a multimedia presentation associated with the submitter;
analyzing the submitter profile data and the multimedia presentation data to determine a presentation rating associated with the multimedia presentation;
publishing availability of the multimedia presentation to the subscriber based on the presentation rating;
receiving a request from the subscriber to view the multimedia presentation;
delivering the multimedia presentation data to the subscriber;
receiving feedback from the subscriber;
updating at least one of the submitter profile data, the subscriber profile data, and the multimedia presentation data to reflect the feedback.

2. The method of claim 1 wherein the step of analyzing includes determining a number of past viewings associated with the multimedia presentation, and the presentation rating is determined based on the number of past viewings.

3. The method of claim 1 wherein the step of analyzing includes determining a number of past viewings associated with the submitter, and the presentation rating is determined based on the number of past viewings.

4. The method of claim 1 wherein the step of analyzing includes determining a submitter rating associated with submitter, and the presentation rating is determined based on the submitter rating.

5. The method of claim 4 wherein the submitter rating represents a quality of at least one past multimedia presentation associated with the submitter.

6. The method of claim 4 wherein the submitter rating represents the opinion of at least one subscriber regarding a quality of at least one past multi media presentation associated with the submitter.

7. The method of claim 1 wherein the step of analyzing includes determining a number of presentations associated with the submitter, and the presentation rating is determined based on the number of presentations.

8. The method of claim 1 wherein the step of analyzing includes determining a topic associated with the multimedia presentation, and the presentation rating is determined based on the topic.

9. An system for distributing a multimedia presentation, comprising:
a processor;
a memory connected to the processor storing a program to control operation of the processor;
the processor operative with the program in the memory to:
receive and store submitter profile data representing a submitter, subscriber profile data representing a subscriber, and multimedia presentation data representing a multimedia presentation associated with the submitter;
analyze the submitter profile data and the multimedia presentation data to determine a presentation rating associated with the multimedia presentation;
publish availability of the multimedia presentation to the subscriber based on the presentation rating;
receive a request from the subscriber to view the multimedia presentation;
deliver the multimedia presentation data to the subscriber;
receive feedback from the subscriber;
update at least one of the submitter profile data, the subscriber profile data, and the multimedia presentation data to reflect the feedback.

10. The system of claim 9 wherein the processor is further operative with the program in the memory to determine a number of past viewings associated with the multimedia presentation, and determine the presentation rating based on the number of past viewings.

11. The system of claim 9 wherein the processor is further operative with the program in the memory to determine a number of past viewings associated with the submitter, and determine the presentation rating based on the number of past viewings.

12. The system of claim 9 wherein the processor is further operative with the program in the memory to determine a submitter rating associated with submitter, and determine the presentation rating based on the submitter rating.

13. The system of claim 12 wherein the submitter rating represents a quality of at least one past multimedia presentation associated with the submitter.

14. The system of claim 12 wherein the submitter rating represents the opinion of at least one subscriber regarding a quality of at least one past multimedia presentation associated with the submitter.

15. The system of claim 9 wherein the processor is further operative with the program in the memory to determine a number of presentations associated with the submitter, and determine the presentation rating based on the number of presentations.

16. The system of claim 9 wherein the processor is further operative with the program in the memory to determine a topic associated with the multimedia presentation, and determine the presentation rating based on the topic.
